(19) United States
(12) Patent Application Publication
(10) Pub. No.: US 2025/0163255 A1
(43) Pub. Date: May 22, 2025

(54) POLYMERIC BLEND CONTAINING A RECYCLED POLYPROPYLENE AND A HIGH CRYSTALLINITY POLYPROPYLENE HOMOPOLYMER

(71) Applicant: FINA TECHNOLOGY, INC., Houston, TX (US)

(72) Inventors: Theodore HARRIS, Houston, TX (US); Joachim AZZI, Houston, TX (US); Peng LI, Houston, TX (US)

(21) Appl. No.: 18/516,551

(22) Filed: Nov. 21, 2023

(51) Int. Cl. C08L 23/12

(52) U.S. Cl. CPC C08L 23/12; C08L 2205/025; C08L 2207/20

(57) ABSTRACT

Disclosed is a polymeric composition containing at least 98 wt. %, based on the total weight of the polymeric composition, of a blend of a recycled polypropylene and a high crystallinity polypropylene homopolymer. The polymeric composition can have a melt flow index of less than 10 g/10 min (e.g., less than 4.5 g/10 min), as measured in accordance with ASTM D-1238, and a flexural modulus of at least 220,000 psi. Processes for producing the polymeric composition and articles containing the polymeric composition are also disclosed.

### CROSS REFERENCE TO RELATED APPLICATIONS

None.

### BACKGROUND OF THE INVENTION

### A. Field of the Invention

The invention generally concerns polymeric compositions. The compositions can include a blend of recycled polypropylene and a high crystallinity polypropylene homopolymer. The polymeric composition can have a relatively low melt flow index and/or a relatively high stiffness/flexural modulus.

### B. Description of Related Art

Plastic recycling involves collecting used plastic materials, processing them to create new products, and reusing them in the production of new plastic items. This process helps to conserve resources, reduce waste, and minimize the environmental impact of plastic pollution. Plastics recycling has become an increasingly important trend in recent years due to a combination of growing public awareness, environmental concerns, and government initiatives aimed at reducing plastic waste in the environment.

Transitioning to a circular economy that retains plastic in its highest value condition can be helpful in reducing environmental impacts by reducing the use of raw materials through re-use and recycling. Mechanical recycling and advanced recycling are two processes used to recycle plastics. Advanced recycling can process a wider range of plastics than mechanical recycling and produce virgin-like plastics. However, various advanced recycling techniques are still in the early stages of development, may face regulatory hurdles, and may require significant capital investment to be utilized at a commercial scale.

Mechanical recycling, by comparison, is a cost-effective process that is energy efficient and that is already widely practiced with a developed collection infrastructure. However, each time that a plastic is mechanically recycled, its properties can degrade, potentially leading to a loss in quality and/or performance. To illustrate, each time that a plastic (e.g., a polypropylene) is recycled in such a manner, the plastic is subjected to mechanical stress and is exposed to heat and oxygen, which can result in degradation of one or more physical and/or mechanical properties. In particular, the molecular weight of the recycled content plastic (e.g., polypropylene) may decrease (e.g., due to polymer chain scission) relative to its original state. This reduction of molecular weight can result in a final product with reduced stiffness and/or an increased melt flow rate, such that the final product's properties can be unsatisfactory for the final product to be used for a particular application.

### SUMMARY OF THE INVENTION

A discovery has been made that provides a solution to at least one or more of the aforementioned problems associated with mechanically recycled polypropylene (PP). In one aspect, the solution can include blending mechanically recycled PP (e.g., a recycled PP homopolymer, a recycled PP random copolymer, or a combination thereof) with high crystallinity polypropylene (HCPP). Such a blend can result in a polymeric composition that has a relatively low melt flow index (e.g., a melt flow index of less than 10 g/10 min, preferably less than 4.5 g/10 min) and/or a relatively high stiffness/flexural modulus (e.g., a flexural modulus of at least 220,000 psi). Notably, these mechanical properties can be obtained by using relatively high amounts of mechanically recycled PP in the blend (e.g., at least 30 wt. % of the blend can include mechanically recycled PP). An advantage of the present invention is that more products can be made with mechanically recycled PP without jeopardizing the mechanical properties of the products. That is to say, the present invention allows for more use of mechanically recycled PP, which can be helpful to the environment by conserving resources and/or reducing PP waste.

One aspect of the present invention is directed to a polymeric composition. The polymeric composition can contain a blend of a recycled polypropylene (rPP) and a HCPP homopolymer. In some aspects, the polymeric composition can contain at least 98 wt. % (or 98.1, 98.2, 98.3, 98.4, 98.5, 98.6, 98.7, 98.8, 98.9, 99.0, 99.1, 99.2, 99.3, 99.4, 99.5, 99.6, 99.7, or 99.8 wt. % or any range therein) of the blend of the rPP and the HCPP homopolymer. In some aspects, the rPP can include a recycled PP homopolymer, a recycled PP random copolymer, or a combination thereof. In some aspects, the blend can include at least 30 wt. %, based on the total weight of the blend, of the rPP. In particular aspects, the blend can include 30 wt. % to 50 wt. % (or 30, 31, 32, 33, 34, 35, 36, 37, 38, 39, 40, 41, 42, 43, 44, 45, 46, 47, 48, 49, or 50 wt. % or any range therein) of the rPP, based on the total weight of the blend. In some aspects, the blend can include at least 50 wt. % of the HCPP homopolymer, based on the total weight of the blend. In particular aspects, the blend can include 50 wt. % to 70 wt. % (or 50, 51, 52, 53, 54, 55, 56, 57, 58, 59, 60, 61, 62, 63, 64, 65, 66, 67, 68, 69, or 70 wt. % or any range therein) of the HCPP homopolymer, based on the total weight of the blend.

In some particular aspects, the HCPP homopolymer can have at least one of or all of the following properties: a melt flow index of 2.0 g/10 min, as measured in accordance with ASTM D-1238; a melting point of 165° C., as measured by Differential Scanning calorimetry; and/or less than 1 wt. % of one or more xylene solubles.

In some aspects, the rPP can include a post industrial recycle (PIR) polypropylene, a post consumer recycle (PCR) polypropylene, or a combination thereof. In some particular aspects, the rPP can include (at least) a PIR polypropylene (e.g., a PIR homopolymer, in some cases) and can have at least one of or all of the following properties: a melt flow index of 4.5 g/10 min, as measured in accordance with ASTM D-1238; a melting point of 163° C., as measured by Differential Scanning calorimetry; and/or at least 3.5 wt. % of xylene solubles.

Processes for producing the polymeric composition are also disclosed herein. In some aspects, a process for producing a polymeric composition can include obtaining an extrusion composition that includes a rPP and a HCPP homopolymer. The composition can then be extruded to form a polymeric composition or blend of the present invention. In particular aspects, the rPP and the HCPP homopolymer can be extruded with a twin screw extruder. The produced polymeric composition can have a melt flow index of less than 10 g/10 min (preferably less than 4.5 g/10 min), as measured in accordance with ASTM D-1238 and a flexural modulus of at least 220,000 psi.

The polymeric composition described herein can be an extruded, a blow-molded, an injection-molded, rotational molded, compression molded, and/or thermoformed composition. In certain aspects, the composition can be an extruded composition (e.g., an extruded part and/or film). Certain aspects are directed to an article of manufacture containing a polymeric composition described herein. In some aspects, the article can be an extruded film (e.g., a biaxially oriented film), extruded sheet, blow-molded container, fiber, or injection-molded article.

Other aspects or embodiments of the invention are discussed throughout this application. Any aspect or embodiment discussed with respect to one aspect of the invention applies to other aspects or embodiments of the invention as well and vice versa. Each aspect or embodiment described herein is understood to be aspects or embodiments of the invention that are applicable to other aspects of the invention. It is contemplated that any aspect or embodiment discussed herein can be combined with other aspects or embodiments discussed herein and/or implemented with respect to any method or composition of the invention, and vice versa. Furthermore, compositions and systems of the invention can be used to achieve methods of the invention.

The following includes definitions of various terms and phrases used throughout this specification.

The terms “about” or “approximately” are defined as being close to as understood by one of ordinary skill in the art. In one non-limiting embodiment, the terms are defined to be within 10%, alternatively within 5%, alternatively within 1%, and alternatively within 0.5%.

The terms “wt. %,” “vol. %,” or “mol. %” refer to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component. The terms “ppm” refer to parts per million by weight of a component, based on the total weight, that includes the component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification include any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The phrase “and/or” can include “and” or “or.” To illustrate, X, Y, and/or Z can include: X alone, Y alone, Z alone, a combination of X and Y, a combination of X and Z, a combination of Y and Z, or a combination of X, Y, and Z.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The process and systems of the present invention can “comprise,” “consist essentially of,” or “consist of” particular ingredients, components, compositions, steps, etc., disclosed throughout the specification. With respect to the transitional phrase “consisting essentially of,” in one non-limiting aspect, a basic and novel characteristic of the compositions and processes of the present invention are polymeric compositions containing a blend of a rPP and a HCPP homopolymer. The polymeric compositions can have (1) a melt flow index lower than the rPP when measured under similar conditions, and/or (2) a flexural modulus higher than the rPP when measured under similar conditions.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### DETAILED DESCRIPTION OF THE INVENTION

A polymeric composition of the present invention can include a blend of a rPP and a HCPP homopolymer. In some aspects, the polymeric composition can include at least 98 wt. % of the blend, based on the total weight of the polymeric composition. It has been discovered that such a polymeric composition can have a melt flow index lower than the melt flow index of the rPP, when measured under similar conditions. In some aspects, the polymeric composition can have a melt flow index of less than 10 g/10 min (preferably less than 4.5 g/10 min), as measured in accordance with ASTM D-1238. It has also been discovered that the polymeric composition can have a flexural modulus higher than the flexural modulus of the rPP, when measured under similar conditions. In some aspects, the polymeric composition can have a flexural modulus of at least 220,000 psi.

These and other non-limiting aspects of the present invention are discussed in further detail in the following sections.

### A. Polymeric Compositions

The polymeric compositions of the present invention can contain at least 98 wt. %, such as 98 wt. % to 99.8 wt. %, or at least any one of, at most any one of, equal to any one of, or between any two of 98 wt. %, 98.1 wt. %, 98.2 wt. %, 98.3 wt. %, 98.4 wt. %, 98.5 wt. %, 98.6 wt. %, 98.7 wt. %, 98.8 wt. %, 98.9 wt. %, 99 wt. %, 99.1 wt. %, 99.2 wt. %, 99.3 wt. %, 99.4 wt. %, 99.5 wt. %, 99.6 wt. %, 99.7 wt. %, and 99.8 wt. % of a blend of a rPP and a HCPP homopolymer. In other aspects, the polymeric composition can include 99.9 wt. % of the blend or 100 wt. % of the blend.

The polymeric composition can have a melt flow index lower than the melt flow index of the rPP, when measured under similar conditions. In some aspects, the polymeric composition has a melt flow index of less than 10 g/10 min (e.g., 9.9, 9.8, 9.7, 9.6, 9.5, 9.4, 9.3, 9.2, 9.1, 9.0, 8.9, 8.8, 8.7, 8.6, 8.5, 8.4, 8.3, 8.2, 8.1, 8.0, 7.9, 7.8, 7.7, 7.6, 7.5, 7.4, 7.3, 7.2, 7.1, 7.0, 6.9, 6.8, 6.7, 6.6, 6.5, 6.4, 6.3, 6.2, 6.1, 6.0, 5.9, 5.8, 5.7, 5.6, 5.5, 5.4, 5.3, 5.2, 5.1, 5.0, 4.9, 4.8, 4.7, 4.6, 4.5, 4.4, 4.3, 4.2, 4.1, 4.0, 3.9, 3.8, 3.7, 3.6, 3.5, 3.4, 3.3, 3.2, 3.1, 3.0, 2.9, 2.8, 2.7, 2.6, 2.5, 2.4, 2.3, 2.2, 2.1, 2.0, 1.9, 1.8, 1.7, 1.6, 1.5, 1.4, 1.3, 1.2, 1.1, 1.0, 0.9, 0.8, 0.7, 0.6, 0.5, 0.4, 0.3, 0.2, 0.1 g/10 min, or any number or range therein), as measured in accordance with ASTM D-1238. In some particular aspects, the polymeric composition can have a melt flow index of less than 4.5 g/10 min (e.g., 4.4, 4.3, 4.2, 4.1, 4.0, 3.9, 3.8, 3.7, 3.6, 3.5, 3.4, 3.3, 3.2, 3.1, 3.0, 2.9, 2.8, 2.7, 2.6, 2.5, 2.4, 2.3, 2.2, 2.1, 2.0, 1.9, 1.8, 1.7, 1.6, 1.5, 1.4, 1.3, 1.2, 1.1, 1.0, 0.9, 0.8, 0.7, 0.6, 0.5, 0.4, 0.3, 0.2, 0.1 g/10 min, or any number or range therein), as measured in accordance with ASTM D-1238. In some particular aspects, the polymeric composition can have a melt flow index of less than 3 g/10 min (e.g., 2.9, 2.8, 2.7, 2.6, 2.5, 2.4, 2.3, 2.2, 2.1, 2.0, 1.9, 1.8, 1.7, 1.6, 1.5, 1.4, 1.3, 1.2, 1.1, 1.0, 0.9, 0.8, 0.7, 0.6, 0.5, 0.4, 0.3, 0.2, 0.1 g/10 min, or any number or range therein), as measured in accordance with ASTM D-1238. In some aspects, the polymeric composition can have a flexural modulus higher than the flexural modulus of the rPP, when measured under similar conditions. In some aspects, the polymeric composition can have can have a flexural modulus of at least 220,000 psi (e.g., 220,000, 225,000, 230,000, 235,000, 240,000, 245,000, 250,000, 255,000, 260,000, 265,000, 270,000, 275,000, 280,000, 285,000, 290,000, 295,000, 300,000, 310,000, 320,000, 330,000, 340,000, 350,000, 360,000, 370,000, 380,000, 390,000, 400,000, 410,000, 420,000, 430,000, 440,000, 450,000, 460,000, 470,000, 480,000, 490,000, 500,000 psi, or any range or number therein).

### 1. Recycled Polypropylene

The compositions of the present invention can include polypropylene. The polypropylene can be virgin or recycled or reclaimed polypropylene. “Virgin polypropylene” can include polypropylene that has not been recycled, either industrially or through the consumer waste stream. Virgin propylene can include a polypropylene that has not been used in a manufacturing process of a plastic product or has otherwise been recycled or reclaimed. “Recycled polypropylene” or “reclaimed polypropylene” can be used interchangeably throughout this specification and can include, for example, polymeric material identified by a material re-processor that may have been extruded after initial processing by the original material manufacturer. The recycled polypropylene may come from post-consumer sources, or from a mixture of post-industrial and post-consumer sources, preferably rigid food and consumer packaging. In one aspect, a source of recycled polypropylene can include blow molded bottles, film, syringe cases, intravenous bags, tubing, and tubing fittings. “Recycled” PP can include post-consumer recycled (PCR) PP, or a mixture of PCR-PP and post-industrial recycled (PIR) PP. With respect to PCR polypropylene, the rPP can also contain at least some polyethylene (PE) associated with cross contamination of PP with PE due to the nature of post-consumer recycling and the difficulty of separating the two materials easily. Accordingly, in some aspects, PCR polypropylene can include at least 5 wt. % (e.g., 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, or 7 wt. % or more or any range or number therein) of polyethylene.

The polypropylene used in the context of the present invention can include a propylene homopolymer and/or a propylene copolymers. If the propylene is a copolymer, the comonomer can be any alpha-olefin i.e. any C2 to C12 alpha-alkylene. The copolymer can be either a random or heterophasic copolymer. In preferred aspects, the polypropylene is a propylene homopolymer. The polypropylene can be atactic, isotactic or syndiotactic polypropylene.

In preferred aspects, mechanically recycled PP can be used with the polymeric compositions of the present invention. In one particularly preferred aspect, the rPP that can be used in the polymeric compositions of the present invention can have at least one of or all of the following properties: a melt flow index of 4.5 g/10 min, as measured in accordance with ASTM D-1238; a melting point of 163° C., as measured by Differential Scanning calorimetry; and at least 3.5 wt. % (e.g., 3.6, 3.7, 3.8, 3.9, 4.0, 4.1, 4.2, 4.3, 4.4, 4.5, 4.6, 4.7, 4.8, 4.9, 5, 6, 7, 8, 9, or 10 wt. % or more or any range or number therein) of xylene solubles.

### 2. High Crystallinity Polypropylene Homopolymer

High crystallinity polypropylene homopolymer (HCPP) may include primarily isotactic polypropylene. The isotacticity in polymers may be measured via 13C NMR spectroscopy using meso pentads and can be expressed as percentage of meso pentads (% mmmm). “Meso pentads” can include successive methyl groups located on the same side of the polymer chain. In an embodiment, the HCPP can have a meso pentads percentage of greater than 97%, or greater than 98%, or greater than 99%. The HCPP may comprise some amount of atactic or amorphous polymer. The atactic portion of the polymer can be soluble in xylene, and is thus termed the xylene soluble fraction (XS %). In determining XS %, the polymer can be dissolved in boiling xylene and then the solution cooled to 0° C. that results in the precipitation of the isotactic or crystalline portion of the polymer. The XS % can be that portion of the original amount that remained soluble in the cold xylene. XS % in the polymer can be indicative of the extent of crystalline polymer formed. The total amount of polymer (100%) can include the sum of the xylene soluble fraction and the xylene insoluble fraction, as determined in accordance with ASTM D5492-98. In an embodiment, the HCPP has a xylene soluble fraction of less than 1.5%, or less than 1.0%, or less than 0.5%.

In an embodiment, an HCPP suitable for use in this disclosure may have a density of from 0.895 g/cc to 0.920 g/cc, alternatively from 0.900 g/cc to 0.915 g/cc, and alternatively from 0.905 g/cc to 0.915 g/cc as determined in accordance with ASTM D1505; a melt flow rate of from 0.5 g/10 min. to 30 g/10 min., alternatively from 1.0 g/10 min. to 15 g/10 min., and alternatively from 1.5 g/10 min. to 5.0 g/10 min. as determined in accordance with ASTM D1238; a secant modulus in the machine direction (MD) of from 350,000 psi to 420,000 psi; alternatively from 380,000 psi to 420,000 psi, and alternatively from 400,000 psi to 420,000 psi as determined in accordance with ASTM D882; a secant modulus in the transverse direction (TD) of from 400,000 psi to 700,000 psi, alternatively from 500,000 psi to 700,000 psi, and alternatively from 600,000 psi to 700,000 psi as determined in accordance with ASTM D882; a tensile strength at break in the MD of from 19,000 psi to 28,000 psi, alternatively from 22,000 psi to 28,000 psi, and alternatively from 25,000 psi to 28,000 psi as determined in accordance with ASTM D882; a tensile strength at break in the TD of from 20,000 psi to 40,000 psi, alternatively from 30,000 psi to 40,000 psi, and alternatively of from 35,000 psi to 40,000 psi as determined in accordance with ASTM D882; an elongation at break in the MD from 50% to 200%, alternatively from 100% to 180%, and alternatively from 120% to 150% as determined in accordance with ASTM D882; an elongation at break in the TD of from 50% to 150%, alternatively from 60% to 100%, and alternatively from 80% to 100% as determined in accordance with ASTM D882; a melting temperature of from 150° C. to 170° C., alternatively from 155° C. to 170° C., and alternatively from 160° C. to 170° C. as determined by differential scanning calorimetry; a gloss at 45° of from 70 to 95, alternatively from 75 to 90, and alternatively from 80 to 90 as determined in accordance with ASTM D2457; a percentage haze of from 0.5% to 2.0%, alternatively from 0.5% to 1.5%, and alternatively from 0.5% to 1.0% as determined in accordance with ASTM D1003; and a water vapor transmission rate of from 0.15 to 0.30 g-mil/100 in2/day, alternatively from 0.15 to 0.25 g-mil/100 in2/day, and alternatively from 0.20 to 0.21 g-mil/100 in2/day as determined in accordance with ASTM F1249-90.

According to particular aspects, the HCPP homopolymer that can be used in the polymeric compositions of the present invention can have at least one of or all of the following properties: a melt flow index of 2.0 g/10 min at 230° C., 2.16 kg, as measured in accordance with ASTM D-1238; a melting point of 165° C., as measured by Differential Scanning calorimetry; and less than 1 wt. % (e.g., 0.9, 0.8, 0.7, 0.6, 0.5, 0.4, 0.3, 0.2, 0.1, 0.09, 0.08, 0.07, 0.06, 0.05, 0.04, 0.03, 0.02, 0.01 wt. % or less (e.g., 0 wt. %) or any range or number therein) of one or more xylene solubles.

An example of a commercially available HCPP homopolymer includes, but is not limited to, Polypropylene 3270, which is commercially available from TotalEnergies (Houston, Texas, USA). Polypropylene 3270 has a melt flow of 2.0 g/10 min (ASTM D-1238), a tensile strength of 28,000 psi (ASTM D-882), an elongation of 150% (ASTM D-882), a tensile modulus of 420,000 psi (ASTM D-882), a melting point of 329° F. (DSC), and a density of 0.91 g/cc (D-1505).

### 3. Additives

In some aspects, the polymeric compositions of the present invention can further contain one or more additives selected from antioxidants, stabilizers, peroxides, slip agents, antistatic/release agents, FR additives, light stabilizers, flow modifiers, process aids, anti-block agents and/or optical brighteners. In some aspects, the polymeric compositions of the present invention can further include an acid neutralizer, an antistatic/release agent, a nucleator, a clarifier, an antioxidant, a stabilizer, or any combinations thereof.

In some aspects, the acid neutralizer can be a metal stearate, metallic oxides, hydrotalcite, or any combination thereof. In some aspects, metal stearate can be calcium stearate, zinc stearate, potassium stearate, sodium stearate, lithium stearate, aluminum stearate, magnesium stearate, manganese stearate, cobalt stearate, cerium stearate, copper stearate, ferric stearate, nickel stearate, a M-series catalyst neutralizer available from Mitsui Plastics, Inc. (e.g., M7L neutralizer), or any combinations thereof. The M-Series catalyst neutralizer can include a metal stearate/metal oxide mixture of calcium stearate, zinc stearate, and zinc oxide (e.g., M3L, M7L, M37L, M70P, M737LP, or any combination thereof, each of which is commercially available neutralizer from Mitsui Plastics, Inc. (White Plains, New York)). In some particular aspects, the metal stearate is calcium stearate.

In certain aspects, the polymeric compositions of the present invention can contain at least 0.01 wt. %, such as 0.01 wt. % to 1.0 wt. %, or at least any one of, at most any one of, equal to any one of, or between any two of 0.01 wt. % to 1.0 wt. %, or at least any one of, at most any one of, equal to any one of, or between any two of 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.11 wt. %, 0.12 wt. %, 0.13 wt. %, 0.14 wt. %, 0.15 wt. %, 0.16 wt. %, 0.17 wt. %, 0.18 wt. %, 0.19 wt. %, 0.2 wt. %, 0.21 wt. %, 0.22 wt. %, 0.23 wt. %, 0.24 wt. %, 0.25 wt. %, 0.26 wt. %, 0.27 wt. %, 0.28 wt. %, 0.29 wt. %, 0.3 wt. %, 0.31 wt. %, 0.32 wt. %, 0.33 wt. %, 0.34 wt. %, 0.35 wt. %, 0.36 wt. %, 0.37 wt. %, 0.38 wt. %, 0.39 wt. %, 0.4 wt. %, 0.41 wt. %, 0.42 wt. %, 0.43 wt. %, 0.44 wt. %, 0.45 wt. %, 0.46 wt. %, 0.47 wt. %, 0.48 wt. %, 0.49 wt. %, 0.5 wt. %, 0.51 wt. %, 0.52 wt. %, 0.53 wt. %, 0.54 wt. %, 0.55 wt. %, 0.56 wt. %, 0.57 wt. %, 0.58 wt. %, 0.59 wt. %, 0.6 wt. %, 0.61 wt. %, 0.62 wt. %, 0.63 wt. %, 0.64 wt. %, 0.65 wt. %, 0.66 wt. %, 0.67 wt. %, 0.68 wt. %, 0.69 wt. %, 0.7 wt. %, 0.71 wt. %, 0.72 wt. %, 0.73 wt. %, 0.74 wt. %, 0.75 wt. %, 0.76 wt. %, 0.77 wt. %, 0.78 wt. %, 0.79 wt. %, 0.8 wt. %, 0.81 wt. %, 0.82 wt. %, 0.83 wt. %, 0.84 wt. %, 0.85 wt. %, 0.86 wt. %, 0.87 wt. %, 0.88 wt. %, 0.89 wt. %, 0.9 wt. %, 0.91 wt. %, 0.92 wt. %, 0.93 wt. %, 0.94 wt. %, 0.95 wt. %, 0.96 wt. %, 0.97 wt. %, 0.98 wt. %, 0.99 wt. %, and 1.0 wt. % of a metal stearate, such as calcium stearate.

In some aspects, the antistatic/release agent can be a glycerol ester. In some particular aspects, the antistatic/release agent can be a glycerol monostearate (PATIONIC® 1052K, Corbion). In some aspects, the polymeric compositions can further contain at least 0.01 wt. %, such as 0.01 wt. % to 1.0 wt. %, or at least any one of, at most any one of, equal to any one of, or between any two of 0.01 wt. % to 1.0 wt. %, or at least any one of, at most any one of, equal to any one of, or between any two of 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.11 wt. %, 0.12 wt. %, 0.13 wt. %, 0.14 wt. %, 0.15 wt. %, 0.16 wt. %, 0.17 wt. %, 0.18 wt. %, 0.19 wt. %, 0.2 wt. %, 0.21 wt. %, 0.22 wt. %, 0.23 wt. %, 0.24 wt. %, 0.25 wt. %, 0.26 wt. %, 0.27 wt. %, 0.28 wt. %, 0.29 wt. %, 0.3 wt. %, 0.31 wt. %, 0.32 wt. %, 0.33 wt. %, 0.34 wt. %, 0.35 wt. %, 0.36 wt. %, 0.37 wt. %, 0.38 wt. %, 0.39 wt. %, 0.4 wt. %, 0.41 wt. %, 0.42 wt. %, 0.43 wt. %, 0.44 wt. %, 0.45 wt. %, 0.46 wt. %, 0.47 wt. %, 0.48 wt. %, 0.49 wt. %, 0.5 wt. %, 0.51 wt. %, 0.52 wt. %, 0.53 wt. %, 0.54 wt. %, 0.55 wt. %, 0.56 wt. %, 0.57 wt. %, 0.58 wt. %, 0.59 wt. %, 0.6 wt. %, 0.61 wt. %, 0.62 wt. %, 0.63 wt. %, 0.64 wt. %, 0.65 wt. %, 0.66 wt. %, 0.67 wt. %, 0.68 wt. %, 0.69 wt. %, 0.7 wt. %, 0.71 wt. %, 0.72 wt. %, 0.73 wt. %, 0.74 wt. %, 0.75 wt. %, 0.76 wt. %, 0.77 wt. %, 0.78 wt. %, 0.79 wt. %, 0.8 wt. %, 0.81 wt. %, 0.82 wt. %, 0.83 wt. %, 0.84 wt. %, 0.85 wt. %, 0.86 wt. %, 0.87 wt. %, 0.88 wt. %, 0.89 wt. %, 0.9 wt. %, 0.91 wt. %, 0.92 wt. %, 0.93 wt. %, 0.94 wt. %, 0.95 wt. %, 0.96 wt. %, 0.97 wt. %, 0.98 wt. %, 0.99 wt. %, and 1.0 wt. % of the antistatic/release agent.

In some aspects, the nucleator can be an organophosphate salt, a norbornane carboxylic-acid salt, or any combinations thereof. In some particular aspects, the nucleator can be a cis-endo-bicyclo(2.2.1) heptane-2,3-dicarboxylic acid sodium salt, a sodium 2.2-methylene-bis-(4,6-di-tert-butylphenyl) phosphate, or any combinations thereof. In some particular aspects, the polymeric compositions can contain at least 0.005 wt. %, such as 0.005 wt. % to 1.0 wt. %, or at least any one of, at most any one of, equal to any one of, 0.005 wt. %, 0.006 wt. %, 0.007 wt. %, 0.008 wt. %, 0.009 wt. %, 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.11 wt. %, 0.12 wt. %, 0.13 wt. %, 0.14 wt. %, 0.15 wt. %, 0.16 wt. %, 0.17 wt. %, 0.18 wt. %, 0.19 wt. %, 0.2 wt. %, 0.21 wt. %, 0.22 wt. %, 0.23 wt. %, 0.24 wt. %, 0.25 wt. %, 0.26 wt. %, 0.27 wt. %, 0.28 wt. %, 0.29 wt. %, 0.3 wt. %, 0.31 wt. %, 0.32 wt. %, 0.33 wt. %, 0.34 wt. %, 0.35 wt. %, 0.36 wt. %, 0.37 wt. %, 0.38 wt. %, 0.39 wt. %, 0.4 wt. %, 0.41 wt. %, 0.42 wt. %, 0.43 wt. %, 0.44 wt. %, 0.45 wt. %, 0.46 wt. %, 0.47 wt. %, 0.48 wt. %, 0.49 wt. %, 0.5 wt. %, 0.51 wt. %, 0.52 wt. %, 0.53 wt. %, 0.54 wt. %, 0.55 wt. %, 0.56 wt. %, 0.57 wt. %, 0.58 wt. %, 0.59 wt. %, 0.6 wt. %, 0.61 wt. %, 0.62 wt. %, 0.63 wt. %, 0.64 wt. %, 0.65 wt. %, 0.66 wt. %, 0.67 wt. %, 0.68 wt. %, 0.69 wt. %, 0.7 wt. %, 0.71 wt. %, 0.72 wt. %, 0.73 wt. %, 0.74 wt. %, 0.75 wt. %, 0.76 wt. %, 0.77 wt. %, 0.78 wt. %, 0.79 wt. %, 0.8 wt. %, 0.81 wt. %, 0.82 wt. %, 0.83 wt. %, 0.84 wt. %, 0.85 wt. %, 0.86 wt. %, 0.87 wt. %, 0.88 wt. %, 0.89 wt. %, 0.9 wt. %, 0.91 wt. %, 0.92 wt. %, 0.93 wt. %, 0.94 wt. %, 0.95 wt. %, 0.96 wt. %, 0.97 wt. %, 0.98 wt. %, 0.99 wt. %, and 1.0 wt. % of the nucleator.

In some aspects, the clarifier can be a sorbitol-based clarifier, a nonitol-based clarifier, an amide-based clarifier, or any combinations thereof. In certain aspects, the sorbitol-based clarifier can be 1,3:2,4-Bis(3,4-dimethylobenzylideno) sorbitol, also known as MILLAD® 3988 (Milliken). In certain aspects, the nonitol-based clarifier can be 1,2,3-trideoxy-4,6:5,7-bis-0-((4-propylphenyl)methylene) nonitol, also known as MILLAD® NX® 8000 (Milliken). In certain aspects, the amide-based clarifier can be N-[3,5-bis-(2,2-dimethyl-propionylamino)-phenyl]-2,2-dimethylpropionamide, also known as IRGACLEAR® XT 386 (BASF). In some particular aspects, the polymeric compositions can contain less than 950 parts per million (ppm) of the clarifier, less than 500 ppm of the clarifier, or less than 250 ppm of the clarifier.

In some aspects, the antioxidant can be a hindered phenol-based antioxidant. In some aspects, the hindered phenol-based antioxidant can be pentaerythritol tetrakis [3-[3,5-di-tert-butyl-4-hydroxyphenyl]propionate, octadecyl-3-[3,5-di-tert-butyl-4-hydroxyphenyl]propionate], pentaerythritol tetrakis[3-[3,5-di-tert-butyl-4-hydroxyphenyl]propionate, or 1,3,5-tris(3,5-di-tert-butyl-4-hydroxybenzyl)-1,3,5-triazine-2,4,6 (1H,3H,5H)-trione, or any combinations thereof. In some particular aspects, the antioxidant can be pentaerythritol tetrakis[3-[3,5-di-tert-butyl-4-hydroxyphenyl]propionate (IRGANOX® 1010, BASF). In some aspects, the polymeric compositions can further contain at least 0.01 wt. %, such as 0.01 wt. % to 0.3 wt. %, or at least any one of, at most any one of, equal to any one of, or between any two of 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.11 wt. %, 0.12 wt. %, 0.13 wt. %, 0.14 wt. %, 0.15 wt. %, 0.16 wt. %, 0.17 wt. %, 0.18 wt. %, 0.19 wt. %, 0.2 wt. %, 0.21 wt. %, 0.22 wt. %, 0.23 wt. %, 0.24 wt. %, 0.25 wt. %, 0.26 wt. %, 0.27 wt. %, 0.28 wt. %, 0.29 wt. %, and 0.3 wt. % of the antioxidant (e.g., IRGANOX® 1010, BASF).

In some aspects, the stabilizer can be a phosphite-containing stabilizer and/or oligomeric hindered amine-containing stabilizer. In some aspects, the phosphite-containing stabilizer can be tris(2,4-di-tert.-butylphenyl)phosphite (IRGAFOS® 168, BASF). In some aspects, the oligomeric hindered amine-containing stabilizer can be butanedioic acid, dimethylester, polymer with 4-hydroxy-2,2,6,6-tetramethyl-1-piperidine ethanol, or any combination thereof. In some aspects, the polymeric compositions can further contain at least 0.01 wt. %, such as 0.01 wt. % to 0.3 wt. %, or at least any one of, at most any one of, equal to any one of, or between any two of 0.01 wt. %, 0.02 wt. %, 0.03 wt. %, 0.04 wt. %, 0.05 wt. %, 0.06 wt. %, 0.07 wt. %, 0.08 wt. %, 0.09 wt. %, 0.1 wt. %, 0.11 wt. %, 0.12 wt. %, 0.13 wt. %, 0.14 wt. %, 0.15 wt. %, 0.16 wt. %, 0.17 wt. %, 0.18 wt. %, 0.19 wt. %, 0.2 wt. %, 0.21 wt. %, 0.22 wt. %, 0.23 wt. %, 0.24 wt. %, 0.25 wt. %, 0.26 wt. %, 0.27 wt. %, 0.28 wt. %, 0.29 wt. %, and 0.3 wt. % of the stabilizer.

### B. Processes for Producing the Polymeric Compositions

The polymeric compositions of the present invention can be made by various methods known in the art. Non-limiting methods include extrusion, blow-molding, injection-molding, rotational molding, compression molding, thermoforming, or the like. For example, components such as the rPP, the HCPP homopolymer, and/or one or more (optional) additives can be mixed, such as dry blended, and then melt-blended, such as extruded, to form the polymeric composition. The extruder used can be any type of extruder known in the art. The extrusion can be performed at a temperature high enough to melt the composition, but as low as possible to avoid excessive thermal degradation of the components.

In some aspects, a process for producing a polymeric composition can include obtaining an extrusion composition that includes at least 98 wt. %, based on the total weight of the composition, of a blend of a rPP and a HCPP homopolymer. In some particular aspects, the process can further include extruding the extrusion composition through a twin screw extruder to form the polymeric composition. In some particular aspects, the blend can include at least 50 wt. % (e.g., 50 wt. % to 70 wt. %), based on the total weight of the blend, of the high crystallinity polypropylene homopolymer. In some particular aspects, the blend can include at least 30 wt. % (e.g., 30 wt. % to 50 wt. %), based on the total weight of the blend, of the recycled polypropylene.

### C. Articles Containing the Polymeric Compositions

The polymeric compositions of the present invention can be comprised in an article of manufacture. In some aspects, the article of manufacture can be an extruded, a blow-molded, an injection-molded, a rotational-molded, a compression-molded and/or thermoformed article. In some particular aspects, the article of manufacture can be an extruded composition (e.g., an extruded part and/or film). In some particular aspects, the article can be an extruded film (e.g., a biaxially oriented film), extruded sheet, blow-molded container, fiber, or injection-molded article.

Non-limiting examples of articles of manufacture can include: a medical sharps container, tote, bins, pipettes, laboratory ware, food packaging container, food storage container, cooking utensil, plate, cup, cavity tray, drinking cup, measuring cup, strainer, turkey baster, non-food storage container, filing cabinet, cabinet drawer, general storage device, organizer, sweater box, rigid packaging, deli container, deli container lid, dairy container, dairy container lid, personal care product bottle and jar, furniture, furniture component, building material and building container components, film, coating, fiber, bag, adhesive, yarn and fabric blister, clamshell, etc., In these and other uses the polymeric compositions may be combined with other materials, such as particulate materials, including talc, calcium carbonate, wood, and fibers, such as glass or graphite fibers, to form composite materials.

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

Polymeric compositions C-1 to C-4 were made with components as shown in Table 1. Formulations were made using Polyproplyene 3270 (TotalEnergies) as the base resin for the HCPP homopolymer. Composition C-1 represents a “control” sample in which “virgin” Polyproplyene 3270 (TotalEnergies) was used as the base resin for the HCPP homopolymer. Composition C-2 represents a “control” sample in which a PIR PP (in the form of pellets) was used as the rPP homopolymer. Compositions C-1 to C-4 were formed via an extrusion process that utilized a twin screw extruder.

Compositions C-1 to C-4 were injection molded into ASTM specimens according to ASTM specifications as injection molded bars at a thickness of 3.2 mm (0.125 in), and characterizations for mechanical properties were determined by evaluating their behavior when subjected to a force or load during testing. The mechanical properties of the injection molded bars comprising Compositions C-1 to C-4 are provided in Table 2.

Compositions C-1 to C-4 were injection molded into ASTM specimens according to ASTM specifications. The melt flow was substantially consistent for each of Compositions C-1 to C-4. The thermal properties of Compositions C-1 to C-4 are provided in Table 3.

TABLE 1
Polymeric Compositions

| Component | Polymeric Composition | | | |
|---|---|---|---|---|
| (wt. %) | C-1 | C-2 | C-3 | C-4 |
| 3270 Base Resin¹ | 100 | — | 60 | 50 |
| PIR² | — | 100 | 40 | 50 |

¹Polypropylene 3270 is commercially available from TotalEnergies (Houston, Texas, USA). It is a HCPP homopolymer. It has a tensile modulus of 250,000 psi (ASTM D-638), a tensile strength at yield of 5,000 psi (D-638), an elongation at yield of 6% (D-638), and a flexural modulus of 240,000 psi (ASTM D-790).
²“PIR” is an example of a post industrial mechanically recycled PP homopolymer.

TABLE 2
Mechanical Properties

| | Polymeric Composition | | | |
|---|---|---|---|---|
| Property | C-1 | C-2 | C-3 | C-4 |
| Tensile | 248,464 | 220,165 | 261,310 | 231,619 |
| Modulus | | | | |
| (Psi) | | | | |
| Tensile | 4,954 | 4,858 | 5,342 | 4,923 |
| Strength at | | | | |
| yield (Psi) | | | | |
| Elongation | 6.6 | 8.3 | 7.2 | 8.1 |
| at yield (%) | | | | |
| Tensile | 3,411 | 3,128 | 2,864 | 3,070 |
| Strength at | | | | |
| break (Psi) | | | | |
| Elongation | 377 | 377 | 138 | 195 |
| at break | | | | |
| (%) | | | | |
| Flexural | 238,516 | 206,704 | 247,003 | 229,022 |
| Modulus | | | | |
| (Psi) | | | | |
| Izod- | 0.80 | 0.63 | 0.67 | 0.68 |
| Notched | | | | |
| (ft-lb/in) | | | | |
| Izod- | Complete | Complete | Complete | Complete |
| Break type | | | | |

As can be seen from Table 2, the addition of 3270 as the HCPP homopolymer resulted in increased stiffness (flexural modulus) properties relative to the polymeric composition corresponding to the “baseline” PIR rPP (i.e., Composition C-2).

TABLE 3
Thermal Properties

| | Polymeric Composition | | | |
|---|---|---|---|---|
| Property | C-1 | C-2 | C-3 | C-4 |
| MFR (dg/min) | 2.2 | 4.5 | 2.8 | 2.5 |
| Crystallization | 114.9 | 116.5 | 121.5 | 112.4 |
| Temperature (° C.) | | | | |
| % Crystallinity | 52.9 | 47.5 | 51.6 | 47.0 |

As can be seen from Table 3, the addition of 3270 as the HCPP homopolymer resulted in decreased melt flow (MFR) properties relative to the polymeric composition corresponding to the “baseline” PIR rPP (i.e., Composition C-2) that has experienced some thermal degradation due to the nature of the mechanical recycling process.

The experimental results in the present disclosure revealed that the use of a HCPP homopolymer can improve the mechanical properties, such as increased stiffness (flexural modulus), of a rPP (e.g., a mechanically recycled PP, such as a PIR and/or PCR PP) that has experienced some mechanical degradation due to the nature of the recycling process(es).

The experimental results in the present disclosure also revealed that the use of a HCPP homopolymer can improve the thermal properties, such as decreased melt flow (MFR), of a rPP (e.g., a mechanically recycled PP, such as a PIR and/or PCR PP) that has experienced some thermal degradation due to the nature of the recycling process(es).

Without wishing to be bound by theory, the low melt flow of the HCPP homopolymer (alone or possibly in combination with the high crystallinity of the HCPP homopolymer) may be responsible for such mechanical and/or thermal improvements of the rPP.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

1. A polymeric composition comprising:
at least 98 wt. %, based on the total weight of the polymeric composition, of a blend of:
a recycled polypropylene; and
a high crystallinity polypropylene homopolymer,
wherein the polymeric composition has a melt flow index of less than 10 g/10 min, preferably less than 4.5 g/10 min, as measured in accordance with ASTM D-1238, and a flexural modulus of at least 220,000 psi.

2. The polymeric composition of claim 1, wherein the recycled polypropylene includes a recycled polypropylene homopolymer, a recycled polypropylene random copolymer, or a combination thereof.

3. The polymeric composition of claim 1, wherein the blend includes at least 30 wt. %, based on the total weight of the blend, of the recycled polypropylene.

4. The polymeric composition of claim 1, wherein the blend includes 30 wt. % to 50 wt. %, based on the total weight of the blend, of the recycled polypropylene.

5. The polymeric composition of claim 1, wherein the blend includes at least 50 wt. %, based on the total weight of the blend, of the high crystallinity polypropylene homopolymer.

6. The polymeric composition of claim 1, wherein the blend includes 50 wt. % to 70 wt. %, based on the total weight of the blend, of the high crystallinity polypropylene homopolymer.

7. The polymeric composition of claim 1, wherein the high crystallinity polypropylene homopolymer has at least one of or all of the following properties:
a melt flow index of 2.0 g/10 min, as measured in accordance with ASTM D-1238;
a melting point of 165° C., as measured by Differential Scanning calorimetry; and/or
less than 1 wt. % of one or more xylene solubles.

8. The polymeric composition of claim 1, wherein the recycled polypropylene includes a post industrial recycle (PIR) polypropylene, a post consumer recycle (PCR) polypropylene, or a combination thereof.

9. The polymeric composition of claim 1, wherein the recycled polypropylene has at least one of or all of the following properties:
a melt flow index of 4.5 g/10 min, as measured in accordance with ASTM D-1238;
a melting point of 163° C., as measured by Differential Scanning calorimetry; and/or
at least 3.5 wt. % of xylene solubles.

10. A process for producing a polymeric composition of claim 1, the process comprising extruding a recycled polypropylene and a high crystallinity polypropylene homopolymer to obtain the polymeric composition of claim 1.

11. The process of claim 10, wherein:
the high crystallinity polypropylene homopolymer has at least one of or all of the following properties: a melt flow index of 2.0 g/10 min, as measured in accordance with ASTM D-1238; a melting point of 165° C., as measured by Differential Scanning calorimetry; and/or less than 1 wt. % of xylene solubles; and
the recycled polypropylene has at least one of or all of the following properties: a melt flow index of 4.5 g/10 min, as measured in accordance with ASTM D-1238; a melting point of 163° C., as measured by Differential Scanning calorimetry; and/or at least 3.5 wt. % of xylene solubles.

12. The process of claim 11, wherein the blend includes at least 50 wt. %, preferably 50 wt. % to 70 wt. %, based on the total weight of the blend, of the high crystallinity polypropylene homopolymer.

13. The process of claim 11, wherein the polymeric composition has a melt flow index of 2.5 g/10 min, as measured in accordance with ASTM D-1238.

14. The process of claim 11, wherein the blend includes at least 30 wt. %, preferably 30 wt. % to 50 wt. %, based on the total weight of the blend, of the recycled polypropylene.

15. The process of claim 14, wherein the polymeric composition has a melt flow index of 2.8 g/10 min, as measured in accordance with ASTM D-1238.

16. An article of manufacture comprising the polymeric composition of claim 1.

17. The article of manufacture of claim 16, wherein the polymeric composition is an extruded composition, the extruded composition comprising an extruded part or an extruded film.

18. The article of manufacture of claim 17, wherein the extruded film is a biaxially oriented film.

19. The article of manufacture of claim 16, wherein:
the high crystallinity polypropylene homopolymer has at least one of or all of the following properties: a melt flow index of 2.0 g/10 min, as measured in accordance with ASTM D-1238; a melting point of 165° C., as measured by Differential Scanning calorimetry; and/or less than 1 wt. % of xylene solubles;
the recycled polypropylene includes a recycled polypropylene homopolymer that has at least one of or all of the following properties: a melt flow index of 4.5 g/10 min, as measured in accordance with ASTM D-1238; a melting point of 163° C., as measured by Differential Scanning calorimetry; and/or at least 3.5 wt. % of xylene solubles;
the blend includes 40 wt. % to 60 wt. %, based on the total weight of the blend, of the recycled polypropylene homopolymer; and
the polymeric composition has a melt flow index of 2.5 g/10 min, as measured in accordance with ASTM D-1238.

20. The article of manufacture of claim 16, wherein:
the high crystallinity polypropylene homopolymer has at least one of or all of the following properties: a melt flow index of 2.0 g/10 min, as measured in accordance with ASTM D-1238; a melting point of 165° C., as measured by Differential Scanning calorimetry; and/or less than 1 wt. % of xylene solubles;
the recycled polypropylene includes a recycled polypropylene homopolymer that has at least one of or all of the following properties: a melt flow index of 4.5 g/10 min, as measured in accordance with ASTM D-1238; a melting point of 163° C., as measured by Differential Scanning calorimetry; and/or at least 3.5 wt. % of xylene solubles;
the blend includes 30 wt. % to 50 wt. %, based on the total weight of the blend, of the recycled polypropylene homopolymer; and
the polymeric composition has a melt flow index of 2.8 g/10 min, as measured in accordance with ASTM D-1238.
